(19) United States
(12) Patent Application Publication
(10) Pub. No.: US 2023/0236057 A1
(43) Pub. Date: Jul. 27, 2023

(54) METHOD AND DEVICE FOR CHECKING THE FILL LEVEL OF CONTAINERS

(71) Applicant: KRONES AG, Neutraubling (DE)

(72) Inventors: Stefan PIANA, Koefering (DE); Christof WILL, Obertraubling (DE); Judith MENGELKAMP, Obertraubling (DE); Anton NIEDERMEIER, Offenstetten (DE)

(21) Appl. No.: 17/996,588

(22) PCT Filed: Apr. 13, 2021
(86) PCT No.: PCT/EP2021/059475

§ 371 Date: Oct. 19, 2022

(30) Foreign Application Priority Data
Apr. 24, 2020 (DE) 10 2020 111 254.8

(51) Int. Cl. G01F 23/292

(52) U.S. Cl. CPC G01F 23/292

(57) ABSTRACT

A method for checking the fill level of containers, wherein the containers are transported by a transporter as a container mass flow and measurement data are captured by a sensor unit, and wherein the measurement data are evaluated by an evaluation unit and the fill level of the containers is determined in each case, wherein the measurement data are evaluated by the evaluation unit using an evaluation method that works on the basis of artificial intelligence in order to determine the fill level.

### TECHNICAL FIELD

The invention relates to a method and a device for checking the fill level of containers.

### BACKGROUND AND SUMMARY

There are known methods and devices for checking the fill level of containers in which the containers are transported by a transporter as a container mass flow and measurement data of the containers are captured by a sensor unit. The measurement data is then evaluated by an evaluation unit and the fill level of each container is determined. In particular, a liquid level is determined in the containers, which separates a liquid or pasty phase of a product from a gas arranged above it.

DE 102018133602 A1 discloses a control device for determining a fill level of a container to be filled with a liquid, having a transmitting unit for emitting at least one measuring beam that penetrates the container, and a receiving unit that is assigned to the transmitting unit and receives the measuring beam. At a desired filling state, the measuring beam is reflected at an interface between the liquid and a gas layer arranged above it in a direction deflected by the receiving unit.

DE 102005009176 A1 discloses a method and a device for measuring the fill level of containers, the containers being moved in a transport direction through a measuring station having a slit-like transmitting device for measuring beams and a slit-like receiving device for measuring beams parallel thereto.

WO 03/016886 A1 discloses a method and a device for inspecting filled and closed bottles with a camera that views at least the head and shoulder region of the bottles from the side through telecentric optics from at least two circumferentially different directions from a light source and generates at least two images that are subjected to an image analysis and/or an image comparison, wherein a signal is generated if an impermissible deviation is captured.

The known methods and devices are inferior in that they must be adapted by an experienced user by means of parameters, depending on the container type and/or the product. In addition, in rare cases, for example when dense foam is formed, it may not be possible to reliably determine the level of the product in order to determine the fill level. Furthermore, variations in the container wall, e.g., thickening, color streaks or glass defects, or even the container shape itself, may also cause a distorted representation of the fluid level, which may complicate or even prevent a conventional algorithmic evaluation of the fill level.

It is therefore the object of the present invention to provide a method and a device for checking the fill level of containers, while enabling to be set up with less effort for different container types and/or grades and determination of the fill level more reliably and in a cost-saving manner.

To solve this object, the invention provides a method for checking the fill level of containers.

By evaluating the measurement data by means of the evaluation unit with the evaluation method operating on the basis of artificial intelligence in order to determine the fill level, the evaluation method may be set up equally for different container types and/or grades without requiring renewed parameterization when changing. Consequently, the evaluation method operating on the basis of artificial intelligence no longer needs to be extensively parameterized and optimized by an experienced user in order to specifically set it up for a container type and/or grade. In addition, incorrect settings may be reduced, making the process more reliable and thus more cost-efficient.

The fill level checking method may be used in a beverage processing plant. In particular, it may be downstream of or associated with a filling method for filling the containers with the product and/or a closing method for closing the containers with a closure.

The containers may be designed to contain the filling product, such as a beverage, a food product, a hygiene product, a paste, a chemical, biological and/or pharmaceutical product. The containers may be in the form of bottles, in particular plastic bottles or glass bottles. In particular, plastic bottles may be PET, PEN, HD-PE or PP bottles. Likewise, they may be biodegradable containers or bottles whose main components are made from renewable raw materials, such as sugar cane, wheat, or corn. The containers may be provided with a closure prior to checking the fill level, for example with a crown cork, screw cap, tear-off cap or the like. It is also conceivable that the containers are captured without a closure during the checking of the fill level.

A container type may be a specific container shape. A grade may be a specific type of filling product, for example beer as opposed to a soft drink.

Conceivably, the method may be used to determine a liquid level in the containers that delimits a liquid or pasty phase of the filling material from a gas arranged above it. For example, the liquid level in each of the containers may be a boundary between a beverage and a gas disposed above it. It is also conceivable that the liquid level is a boundary between the liquid or pasty phase of the filling material and foam arranged above it.

The containers may be transported with the transporter to the sensor unit as the container mass flow, preferably as a single-lane container mass flow. However, a multi-lane container mass flow is also conceivable. The transporter may include a carousel and/or a linear transporter. For example, the transporter may include a transporter belt on which the containers are transported standing up into a control area of the sensor unit. Pick-up elements that pick up one or more containers during transport are also conceivable.

The sensor unit may be configured as an optical sensor unit, in particular with a transmitter and with a receiver for electromagnetic radiation, in order to transilluminate and/or illuminate the containers in an area of a target liquid level by means of electromagnetic radiation and/or to capture them with the sensor. The electromagnetic radiation may be light, in particular infrared or visible light. For example, the containers may thus be transilluminated and/or illuminated with transmitted light and/or with incident light. It is also conceivable that the radiation may be X-rays used to transilluminate the containers. The transmitter may include one or more sources for generating the electromagnetic radiation, such as an LED, a laser, and/or an X-ray source. The receiver may include one or more detectors of electromagnetic radiation, such as one or more photodiodes, phototransistors, and/or a photosensitive line or matrix sensor, such as a CCD or CMOS chip. In addition, the sensor unit may include one or more deflection elements for the electromagnetic radiation, such as lenses and/or mirrors.

The evaluation unit may process the measurement data by means of a signal processor and/or a CPU (Central Processing Unit) and/or GPU (Graphics Processing Unit) and/or a TPU (Tensor Processing Unit) and/or a VPU (Vision Processing Unit). It is also conceivable that the evaluation unit includes a memory unit, one or more data interfaces, for example a network interface, a display unit and/or an input unit. Preferably, the evaluation unit may process the measurement data digitally in order to determine the fill level of the respective containers.

The measurement data may be output signals from the sensor unit. The measurement data may be present as a digital or analog data signal. For example, the measurement data may be present as time-resolved and/or spatially-resolved digital data signals.

The fill level may correspond to a relative height of the liquid level with respect to a reference height on the container. The reference height may, for example, be a sealing surface at the container mouth or a lower contact surface at the container bottom. It is also conceivable that the reference height is a fill level marking.

The evaluation method operating on the basis of artificial intelligence may include at least one method step using a deep neural network, wherein the measurement data for determining the fill level is evaluated by using the deep neural network. In this way, the processing of the measurement data of the different container types and/or grades may be abstracted and is thus particularly efficient. In addition, the deep neural network may be trained to the different container types and/or grades without adjusting parameters. The deep neural network may include an input layer, a plurality of hidden layers, and an output layer. The deep neural network may include a so-called convolutional neural network with at least one convolutional layer and with a pooling layer. However, it is also conceivable that the evaluation method operating on the basis of artificial intelligence includes at least one method step using a neural network, wherein the measurement data for determining the fill level is evaluated by means of the neural network.

The sensor unit may include a camera, with which the containers are captured as image data, wherein the measurement data includes the image data. This allows acquisition of extensive measurement data of the containers for determining the fill level by simple means. This makes it easier to detect more complex liquid levels, for example if foam is present above the product, if the fill level is not flat and horizontal due to sloshing, or if it is necessary to distinguish whether the container is full to the brim or not. In the case of clear, colorless containers, this distinction between empty and full may often only be made by observing the change in the refractive index and the associated darkening in the contour area of the container. The camera may include the line or matrix sensor and a lens to image the containers. Preferably, the line sensor or matrix sensor may detect infrared light radiation. Conceivably, the containers may be positioned between the light radiation transmitter and receiver during detection, wherein the receiver includes the camera. The transmitter may be designed as an illumination unit and include one or more LEDs as light sources, in particular infrared and/or visible LEDs. The image data may be camera images, for example TIFF or JPEG files.

The sensor unit may include different sensors, each using a different measurement method, wherein the measurement data of containers are captured with the different sensors. By detecting or capturing the containers with the different measurement methods, the determination of the fill level is particularly reliable. The different sensors may include the camera, a light barrier, in particular a laser light barrier, a plurality of light barriers arranged one above the other, a plurality of photodiodes arranged one above the other, and the like. It is also conceivable that one of the different sensors with a transmitter emits a measuring beam, which penetrates the containers and which is deflected away from or towards a receiver that is in a desired filling state at the liquid level. Sensors for detecting a fill level using radio frequency or X-rays are also conceivable.

The evaluation method operating on the basis of artificial intelligence may be trained with training data sets, each including measurement data of a training container and optionally assigned additional information. In this way, the evaluation method may be trained to check the different container types and/or grades particularly easily. The training measurement data may be the same type of data as the measurement data, in particular image data. The associated additional information may be embedded in the respective training data sets as metadata. For example, the training data sets may each be measurement data of a training container acquired as training measurement data and the fill level may represent associated additional information. A training container may be a container described in more detail above. The training container may be filled with a filling material and, in particular, closed with a closure. It is conceivable that the training data sets include training measurement data of different container types and/or grades of training containers or filling material. The training data may preferably include borderline cases such as a strongly sloshing fill level, product drops above the fill level, gas bubbles in the product, empty or completely filled containers, empty but with relief fogged containers and/or those with diffuse liquid-foam border. This means that the evaluation method, which works on the basis of artificial intelligence, may be trained for a particularly large number of different container types and/or grades and no longer needs to be specially adapted when evaluating the measurement data of the containers.

The training measurement data may be at least partially evaluated by a user, with the additional information being determined manually. In this way, the training measurement data may be evaluated particularly reliably.

It is also conceivable that the training measurement data is at least partially evaluated additionally or alternatively with a further evaluation unit using a conventionally operating evaluation method, with the additional information being determined automatically. In this way, a particularly large number of training data sets of different container types and/or grades may be created automatically. The “conventionally operating evaluation method” may have the meaning here of an evaluation method that is not based on artificial intelligence. In particular, the conventionally operating evaluation method may not have a process step using a neural or deep neural network. It is also conceivable that this means that the conventionally operating evaluation method evaluates the measurement data and/or image data by a transformation operation, point operation, neighbourhood operation, filter operation, histogram operation, threshold operation, brightness operation and/or contrast operation in order to thereby indirectly determine the liquid level in the measurement data.

The training bins may be captured with a different sensor unit than the training measurement data. In this way, the training containers may be acquired, for example, in a test facility of the manufacturer of the beverage processing system, and the training data sets may be created therefrom. It is also conceivable, however, that the training containers are acquired by using the same sensor unit with which the containers of the container mass flow are also acquired as measurement data.

The additional information may include a fill level, a completely overfilled state and/or a completely underfilled state of the training container recorded in the training measurement data, grade information and/or evaluability information about the training measurement data. Thus, the filling state of the training containers may be characterized particularly accurately. In the case of the completely overfilled state and/or the completely underfilled state, the fill level may lie outside a measurement range. The evaluability information may be error information whether an evaluation of the corresponding training measurement data was possible by the user or the conventionally operating evaluation method. It is conceivable, for example, that the liquid level is not clearly recognizable for a particular training container and thus the corresponding training measurement data could not be evaluated.

The training containers with respective different container types and/or grades may be recorded as the training measurement data in order to form the training data sets from them. As a result, a particularly large number of different container shapes and/or product grades may be used for training the evaluation method operating on the basis of artificial intelligence. As a result, a particularly large number of different container types and/or grades may then be subjected to the fill level check without further adapting the evaluation method operating on the basis of artificial intelligence.

In addition, the invention provides a device for checking or checking the fill level of containers for solving the above object.

By designing the evaluation unit so as to evaluate the measurement data with the evaluation method operating on the basis of artificial intelligence in order to determine the fill level, the evaluation unit may be set up equally for different container types and/or grades without the need for renewed parameterization when changing. Consequently, the evaluation method based on artificial intelligence no longer needs to be extensively parameterized and optimized by an experienced user in order to set it specifically to a container type and/or grade. In addition, incorrect settings may be reduced, whereby the method operates more reliably and thus more cost-efficiently.

The device may be arranged in a beverage processing plant. In particular, the device may be arranged downstream of or associated with a filler and/or a capper to control the fill level of the filled product.

The evaluation method based on artificial intelligence may include a deep neural network to evaluate the measurement data for determining the fill level using the deep neural network. This allows the processing of the measurement data of the different container types and/or grades to be abstracted and is thus particularly efficient. In addition, the deep neural network may be trained particularly easily to the different container types and/or grade. The deep neural network may include an input layer, a plurality of hidden layers, and an output layer. The deep neural network may include a so-called convolutional neural network with at least one convolutional layer and with a pooling layer. However, it is also conceivable that the evaluation method operating on the basis of artificial intelligence includes at least one method step using a neural network, wherein the measurement data for determining the fill level are evaluated with the neural network.

The sensor unit may include a camera to capture the containers as image data, wherein the measurement data includes the image data. This allows acquisition of particularly extensive measurement data of the containers for determining the fill level by simple means. This makes it possible, for example, to better detect more complex liquid levels, such as when foam is present above the filling material. The camera may include the line sensor or matrix sensor and a lens to image the containers. Preferably, the line or matrix sensor may detect infrared light radiation. Conceivably, the containers may be positioned between the light radiation transmitter and receiver during detection, with the receiver including the camera. The transmitter may be designed as an illumination unit and include one or more LEDs as light sources, in particular infrared LEDs. The image data may be camera images, for example, TIFF or JPEG files.

The sensor unit may include different sensors, each formed with a different measurement method, to capture the containers as the measurement data. In this way, the containers are captured with the different measurement methods and the determination of the fill level is thus particularly reliable. The different sensors may include the camera, a light barrier, in particular a laser light barrier, a plurality of light barriers arranged one above the other, a plurality of LEDs arranged one above the other, and the like. It is also conceivable that one of the different sensors is designed to use a transmitter to emit a measuring beam that penetrates the containers and that is deflected away from or toward a receiver when the liquid level of the container is at a desired filling state. It is also conceivable that one of the different sensors is designed to detect the fill level using radio frequency or X-rays.

The device may include a computer system including the evaluation unit. Thus, the evaluation unit may be implemented as a computer program product. The computer system may include the signal processor and/or the CPU (Central Processing Unit) and/or the GPU (Graphics Processing Unit) and/or the TPU (Tensor Processing Unit) and/or the VPU (Vision Processing Unit). It is also conceivable that the computer system includes a memory unit, one or more data interfaces, a network interface, a display unit, and/or an input unit. It is conceivable that the evaluation unit and the sensor unit are designed as an integrated system. For example, the computer system may be integrated into the camera or the camera may be designed as an “intelligent” camera.

### BRIEF DESCRIPTION OF THE FIGURES

Further features and advantages of the invention are explained in more detail below with reference to the embodiments shown in the figures. In the figures:

FIG. 1 shows a top view of a device for checking the fill level of containers of an embodiment according to the invention;

FIG. 2 shows an example of measurement data acquired during checking the fill level; and

FIGS. 3A-3B show, as a flow chart, a method of checking the fill level of containers according to an embodiment of the invention.

### DETAILED DESCRIPTION

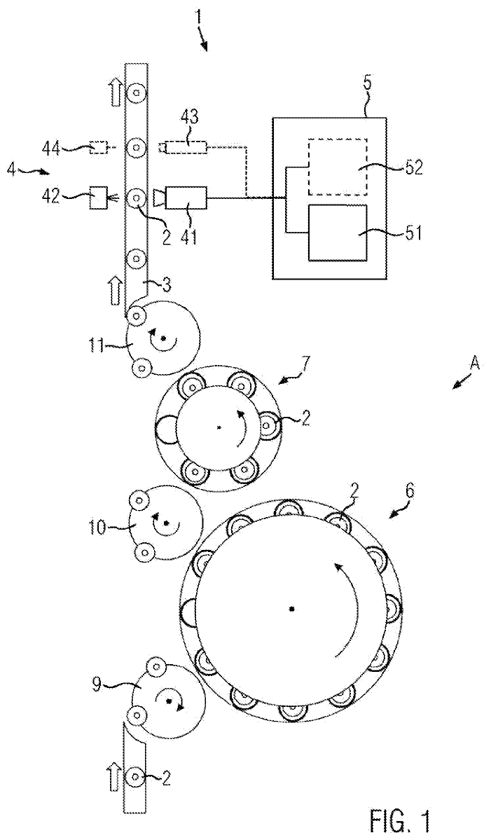

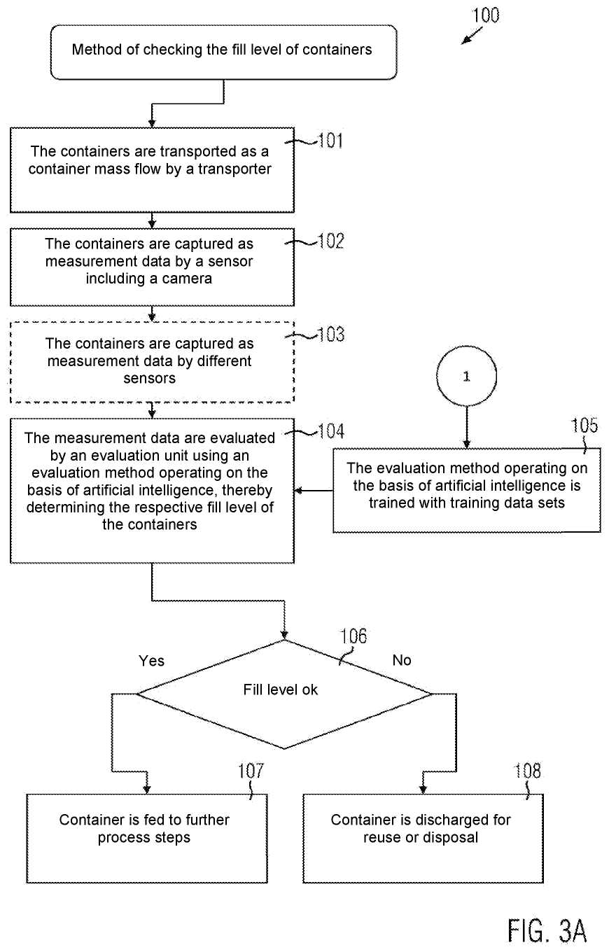

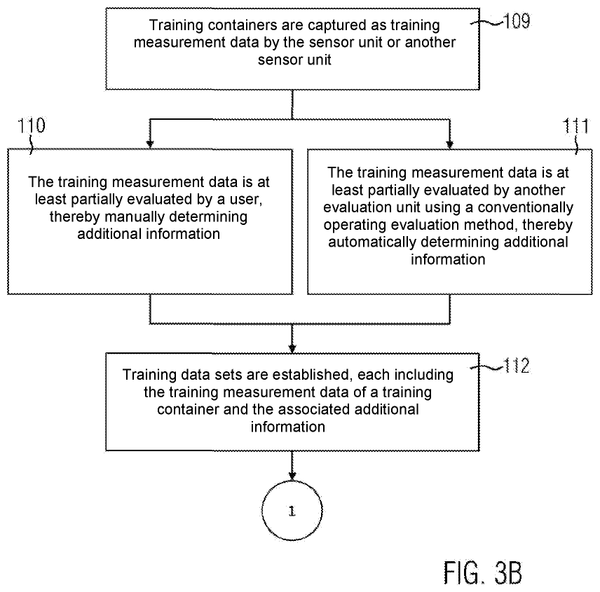

FIG. 1 shows in a top view an embodiment according to the invention of a device 1 for checking the fill level of containers 2. The device 1 is configured for carrying out the method 100 in FIGS. 3A-3B described below.

It is evident that the containers 2 are first transferred to the filler 6 by the inlet starwheel 9 and are filled there with a filling material, for example with a beverage. The filler 6 includes, for example, a carousel with filling elements arranged thereon (not shown here), with which the containers 2 are filled with the filling material during transport. Subsequently, the containers 2 are transferred via the intermediate starwheel 10 to the capper 7, where they are provided with a closure, for example with a cork, crown cork, or screw cap. This protects the contents in the containers 2 from environmental influences and prevents them from leaking out of the containers 2.

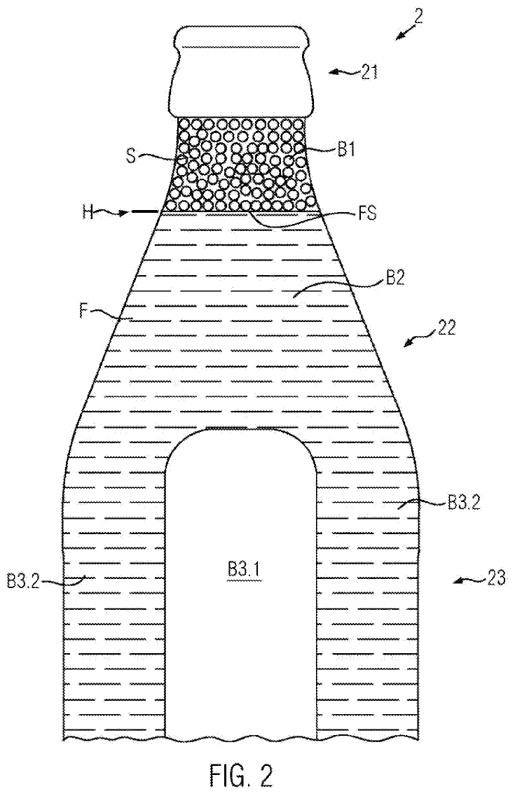

Subsequently, the containers 2 are transferred via the discharge starwheel 11 to the transporter 3, which transports the containers 2 as a container mass flow to the sensor unit 4. The transporter is designed here, by way of example, as a transporter belt, on which the containers 2 are transported in an upright position. The sensor unit 4 arranged thereon includes a first sensor with the illumination device 42 as transmitter and the camera 41 as receiver in order to capture the containers 2 with electromagnetic light radiation in transmitted light. For example, infrared light is used. The illumination device 42 has, for example, a diffusing light emitting disc that is backlit with a plurality of LEDs and that thus forms an illuminated image background for the containers 2 as seen by the camera 41. The camera 41 is then used to capture the measurement data of the containers 2, which is transmitted to the computer system 5 as digital signals. An example of such measurement data from the camera 41 is explained in more detail below with reference to FIG. 2.

In addition, it is conceivable that the containers 2 are optionally captured by a second sensor 43, 44, which operates with a different measuring method than the first sensor 41, 42. For example, an X-ray source 44 and an X-ray receiver 43 may be used as transmitter and as receiver, respectively. When the X-ray beam passes through the product, it is attenuated differently than when it passes through the air or foam above the liquid level. Consequently, the containers 2 may be captured by different measuring methods so that in the subsequent evaluation the fill level may be determined even more reliably for different container types and/or grades.

Furthermore, the computer system 5 with the evaluation units 51, 52 is illustrated. The computer system 5 includes, for example, a CPU, a memory unit, an input and output unit, and a network interface. Accordingly, the evaluation units 51, 52 are implemented in the computer system 5 as a computer program product.

The evaluation unit 51 is designed to evaluate the measurement data of the containers 2 using an evaluation method operating on the basis of artificial intelligence in order to determine the fill level. This is described in more detail below with reference to FIGS. 3A-3B.

The further evaluation unit 52 is only optionally present and is used to evaluate training measurement data acquired from training containers (not shown here) by the sensor unit 4. The further evaluation unit 52 is designed to evaluate the training measurement data of the training containers using a conventionally operating evaluation method and, in the process, to automatically determine additional information associated with the respective training container. The additional information is a desired fill level, a completely overfilled state, and/or a completely underfilled state of the training container recorded in the training measurement data and/or evaluability information for the training measurement data. Consequently, the further evaluation unit 52 may be used to automatically provide a plurality of training data sets on a conventional basis to subsequently train the evaluation method of the evaluation unit 51 operating on the basis of artificial intelligence. This is explained in more detail below with reference to FIGS. 3A-3B.

After checking the fill level, the containers 2 with the desired fill level are fed to further processing steps, for example to a labeling machine and/or a palletizer. In contrast, containers 2 with a different fill level are diverted from the container mass flow by a diverter for recycling or disposal.

FIG. 2 shows an example of measurement data from camera 41 acquired during inspection of the fill level. In this case, it is image data, in which the container 2 is shown in a lateral view with the container body 23, the container shoulder 22 and the container mouth 21. It is evident that the container 2 continues to be filled with the product F, over which the foam S has formed towards the container mouth 21.

It can also be seen that the area B2 near the container shoulder 22 and the areas B3.2 at the edge of the container body 23 are shown dark in the measurement data. In contrast, the central area B3.1 of the container body 23 appears bright. This is due to the fact that the electromagnetic light radiation is refracted by the container's transparent material (for example glass or PET) and the filling material F when passing through the container 2, so that only in the central area B3.1 of the container body 23 a direct light path from the illumination device 42 towards the camera 41 is present.

Furthermore, it is evident that also the area B2 in the vicinity of the container shoulder 22 does not allow any or only a small direct light path due to the even stronger light refraction. Consequently, depending on the grade, this area B2 is more or less penetrated by scattered light. In addition, the foam S towards the camera 41 is also penetrated by scattered light only, since the electromagnetic light radiation is refracted several times by the bubbles of the foam S.

Consequently, the liquid level FS in the measurement data of FIG. 2 may not be identified simply by a jump in brightness. Conventional image processing algorithms would have to be adapted to the type of container and the grade of product F by suitable parameterization. This is where the invention comes in to determine the fill level H.

FIGS. 3A-3B show a flow chart of an embodiment of a method 100 according to the invention for checking the fill level of containers 2. The method 100 is described only by way of example with reference to the device 1 previously described with reference to FIG. 1.

First, in step 101, the containers 2 are transported by the transporter 3 as a container mass flow. This is done, for example, by means of a transporter belt or a carousel. In this process, the containers 2 are transported to the sensor unit 4.

In the subsequent step 102, the measurement data of the containers 2 are captured by the sensor unit 4. For example, the containers 2 are transilluminated by a sensor including the illumination unit 42 and the camera 41 and thus captured in the form of image data.

Optionally, in step 103, the containers 2 are additionally captured by a differently configured sensor. For example, an X-ray beam from the X-ray source 44 passes through the containers 2 and is captured by the X-ray receiver 43. As a result of the fact that the containers 2 are inspected with the different measuring methods of the sensors 41, 42 or 43, 44, the determination of the fill level H is particularly reliable.

Subsequently, in step 104, the measurement data are evaluated with the evaluation unit 51 using an evaluation method operating on the basis of artificial intelligence, whereby the fill level H of each of the containers 2 is determined. For this purpose, the evaluation method includes at least one method step with a deep neural network, for example a convolutional neural network. In this process, the measurement data first pass through an input layer, several convolution layers and/or hidden layers, a pooling layer and an output layer. With the output layer, for example, the fill level H is output directly. It is also conceivable that a completely overfilled state, a completely underfilled state of the container recorded in the measurement data and/or evaluability information is additionally output for the measurement data.

If the fill level H determined in this way is in order according to the following step 106, the containers 2 are fed to further treatment steps in step 107. Otherwise, the containers are rejected for recycling or disposal in step 108.

In order to train the evaluation method of step 104, which operates on the basis of artificial intelligence, it is trained in advance with a large number of training data sets (step 105). The training data sets each include training measurement data of a training container and associated additional information. The additional information describes, for example, the fill level, a completely overfilled state, a completely underfilled state of the training container recorded in the training measurement data, and/or evaluability information about the training measurement data. Consequently, for training the deep neural network, data of both the input layer in the form of the training measurement data and the output layer in the form of the associated additional information are known, and the deep neural network may be trained accordingly on different container types and/or grades. Consequently, the user does not have to elaborately parameterize the evaluation to the different container types and/or grades.

As shown in FIG. 3B, to create the training data sets, the training containers are captured as the training measurement data by the sensor unit 4 or by another sensor unit not shown here (step 109).

Thereafter, in step 110, the training measurement data may be at least partially evaluated by a user to manually determine the additional information. For example, the user may manually mark the fill level H in the image data, as shown in FIG. 2.

Alternatively or additionally, the training measurement data is at least partially evaluated with the further evaluation unit 52 using a conventionally operating evaluation method and the additional information is determined automatically in the process. In this way, a particularly large number of training data sets may be provided. This is suitable, for example, for already known container types, for which the conventionally operating evaluation method works particularly well and reliably.

Subsequently, in step 112, the training data sets are formed, each including the training measurement data of a training container and the associated additional information. The training data sets are then transferred to step 105, thereby training the evaluation method operating on the basis of artificial intelligence.

By evaluating the measurement data by the evaluation unit 51 using the evaluation method operating on the basis of artificial intelligence in order to determine the fill level H, the evaluation method may be set up equally for different container types and/or grades without requiring renewed parameterization when changes occur. Consequently, the evaluation method operating on the basis of artificial intelligence no longer needs to be extensively parameterized and optimized by an experienced user in order to specifically set it up for a container type and/or grade. In addition, incorrect settings may be reduced, whereby the method 100 and the device 1 operate more reliably and thus more cost-efficiently.

It is understood that features mentioned in the previously described embodiments are not limited to these feature combinations, but are also usable individually or in any other feature combinations.

1. A method of checking a fill level of containers, wherein the containers are transported by a transporter as a container mass flow and measurement data of the containers are captured by a sensor unit, and wherein the measurement data are evaluated by an evaluation unit, thereby determining the respective fill level of the containers,
wherein
the measurement data are evaluated by the evaluation unit using artificial intelligence so as to determine the fill level.

2. The method according to claim 1, wherein the evaluation unit using artificial intelligence comprises a deep neural network, wherein the measurement data are evaluated with the deep neural network so as to determine the fill level.

3. The method according to claim 1, wherein the sensor unit comprises a camera, with which the containers are captured as image data, and wherein the measurement data comprises the image data.

4. The method according to claim 1, wherein the sensor unit comprises different sensors, each operating with a different measurement method, and wherein the containers are captured as the measurement data by the different sensors.

5. The method according to claim 1, wherein the evaluation unit using artificial intelligence is trained with training data sets, each comprising training measurement data of a training container.

6. The method according to claim 5, wherein the training measurement data is at least partially evaluated by a user, thereby manually determining additional information.

7. The method according to claim 5, wherein the training measurement data is at least partially evaluated by a further evaluation unit using a conventionally operating evaluation method while automatically determining additional information.

8. The method according to claim 5, wherein the training measurement data of the training container is captured by another sensor unit.

9. The method according to claim 5, further comprising additional information, wherein the additional information comprises at least one of a desired fill level, a completely overfilled state, and a completely underfilled state of the training container captured as the training measurement data, and/or comprises evaluability information about the training measurement data.

10. The method according to claim 8, wherein the training measurement data of a plurality of training containers is captured establish the training data sets therefrom, wherein each of the plurality of training containers is a different container type and/or grade.

11. A device for checking a fill level of containers, wherein measurement data are captured and evaluated to determine the fill level performing, the device comprising
a transporter configured to transport the containers as a container mass flow,
a sensor unit configured to capture the measurement data of the containers, and
an evaluation unit configured to evaluate the measurement data and to determine the fill level of each of the containers,
wherein
the evaluation unit is configured to evaluate the measurement data using artificial intelligence to determine the fill level.

12. The device according to claim 11, wherein the artificial intelligence comprises a deep neural network to evaluate the measurement data for determining the fill level by using the deep neural network.

13. The device according to claim 11, wherein the sensor unit comprises a camera to capture the containers as image data, and wherein the measurement data comprises the image data.

14. The device according to claim 11, wherein the sensor unit comprises different sensors each-configured with a different measurement method to capture the containers as the measurement data.
